(19) United States
(12) Patent Application Publication
(10) Pub. No.: US 2002/0171060 A1
(43) Pub. Date: Nov. 21, 2002

(54) Valve spring retainer

(76) Inventors: Haruki Kobayashi, Fujisawa-shi (JP); Tatsuo Kanzaki, Fujisawa-shi (JP); Takeshi Sassa, Fujisawa-shi (JP)

Correspondence Address: MCKEE, VOORHEES & SEASE, P.L.C., 801 GRAND AVENUE, SUITE 3200, DES MOINES, IA, 50309-2721, US

(21) Appl. No.: 09/909,663

(22) Filed: Jul. 20, 2001

(30) Foreign Application Priority Data
Apr. 3, 2001 (JP) 2001-104402

(51) Int. Cl. F16K 1/00; F02N 3/00

(52) U.S. Cl. 251/337; 123/188.2

(57) ABSTRACT

A valve spring retainer is fixed at the upper end of a poppet valve via a pair of cotters in a valve-operating mechanism of an internal combustion engine. The valve spring retainer comprises a hollow inverted-frustoconical portion and an outward flange at the end thereof. The lower surface of the outward flange retains the upper end of a valve spring on the lower surface. An annular projection is provided on the outward flange to restrict sideward movement of the valve spring and to increase rigidity of the retainer.

### BACKGROUND OF THE INVENTION

The present invention relates to a valve spring retainer in an internal combustion engine, and especially to a sheet metal valve spring retainer.

In a valve-operating mechanism of an internal combustion engine, a valve spring retainer is fixed to the upper end of a poppet valve via a pair of cotters to retain the upper end of a valve spring. The valve spring retainer is formed by forging steel to provide larger thickness. So inertial mass of the valve-operating mechanism cannot be decreased.

To overcome the disadvantage, a valve spring retainer is formed from a sheet metal to lighten it as disclosed in Japanese Utility Model Pub. Nos. 62-185807 and 62-185808.

Large pressing force is applied to an inverted-frustoconical portion of the valve spring retainer in which a pair of cotters is fitted, and large upward reaction force acts to a spring-retaining flange by a valve spring. Thus, high rigidity is required for the valve spring retainer in an automobile engine driven at high speed and high load.

In the above sheet metal valve spring retainer in which the spring-retaining flange is integrally formed at the upper end of the inverted-frustoconical portion, section modulus thereof is low and high rigidity or fatigue strength is not obtained. The lower end of the inverted-frustoconical portion is likely to be enlarged by the cotters, thereby causing the cotters to fall therethrough, or the spring-retaining flange is likely to be deformed upwards or damaged.

In the former of the above prior art, a plurality of downward projections are provided on the spring-retaining flange, and section modulus thereof becomes larger to increase strength. But the remaining portions except the projections are liable to be damaged.

To increase rigidity and fatigue strength in the conventional structure, thickness of the material becomes larger to increase not only section modulus, but also its weight.

In the latter, a plurality of circumferential portions are cut and bent downwards to form a positioning guide, but it leads not only decreased rigidity but also gathered stress to corners.

### SUMMARY OF THE INVENITON

In view of the disadvantages in the prior art, it is an object of the present invention to provide a valve spring retainer in an internal combustion engine, which is formed from a sheet metal to have substantially uniform thickness, providing high rigidity without increasing its weight.

### BRIEF DESCIRIPTION OF THE DRAWINGS

The features and advantages of the invention will become more apparent from the following description with respect to embodiments as shown in appended drawings wherein:

FIG. 1 is a perspective view of the first embodiment of a valve spring retainer according to the present invention;

FIG. 2 is a central vertical sectional front view of a valve-operating mechanism which includes the valve spring retainer in FIG. 1;

FIG. 3 is a central vertical sectional front view of a valve-operating mechanism which includes the second embodiment of a valve spring retainer according to the present invention;

FIG. 4 is a perspective view of the third embodiment of a valve spring retainer according to the present invention;

FIG. 5 is a central vertical sectional front view of a valve-operating mechanism which includes the valve spring retainer in FIG. 4;

FIG. 6 is a central vertical sectional view of a valve-operating mechanism which includes the fourth embodiment of a valve spring retainer according to the present invention;

FIG. 7 is a central vertical sectional view of a valve-operating mechanism which includes the fifth embodiment of a valve spring retainer according to the present invention;

FIG. 8 is a central vertical sectional front view of a valve-operating mechanism which includes the sixth embodiment of a valve spring retainer according to the present invention;

FIG. 9 is a perspective view of the seventh embodiment of a valve spring retainer according to the present invention;

FIG. 10 is a central vertical sectional front view of a valve-operating mechanism which includes the valve spring retainer in FIG. 9;

FIG. 11 is a central vertical sectional front view of the valve spring retainer in FIG. 9;

FIG. 12 is a central vertical sectional front view which shows how to test the valve spring retainer in FIG. 9;

FIG. 13 is a perspective view of the eighth embodiment of a valve spring retainer according to the present invention: and

FIG. 14 is a central vertical sectional front view of a valve-operating mechanism which includes the valve spring retainer in FIG. 13.

### DETAILED DESCRIPTION OF PREFERRED EMBODIMENTS

Embodiments of the present invention will be described with respect to appended drawings.

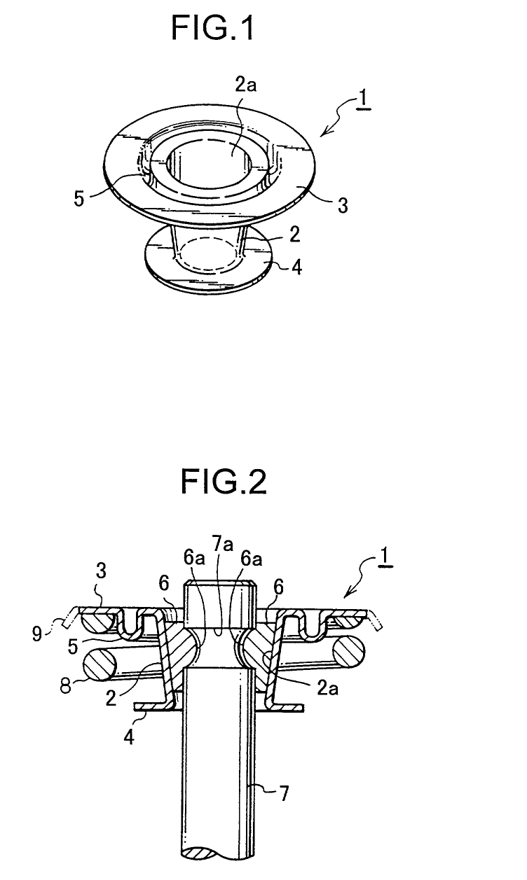

FIG. 1 is a perspective view of the first embodiment of a valve spring retainer according to the present invention, and FIG. 2 is a central vertical sectional front view of a valve-operating mechanism which includes the valve spring retainer.

In FIGS. 1 and 2, the valve spring retainer 1 comprises a hollow inverted-frustoconical portion 2, a spring-retaining flange 3 which is provided outwards at its upper end, a reinforcement flange 4 which is provided outwards at the lower end and an annular downward guide projection 5 of the spring-retaining flange 3. The valve spring retainer 1 is integrally formed from a thin steel plate having thickness of 0.5 to 2 mm by plate working such as stamping, deep drawing and manual spinning.

In the valve spring retainer 1, beads 6a of a pair of cotters 6,6 in a tapered bore 2a of the inverted-frustoconical portion 2 are engaged in an annular groove 7a of the end of a poppet valve 7.

The guide projection 5 of the spring-retaining flange 3 is pressed by the upper end of a valve spring 8, so that the valve spring retainer 1 and the poppet valve 7 are always energized upwards.

The guide projection 5 prevents the upper end of the valve spring from deviating sideward out of the spring-retaining flange 3 and also reinforces the spring-retaining flange 3. In the first embodiment, the outward flange 4 is provided at the lower end of the inverted-frustoconical portion 2 to increase rigidity at the lower end of the inverted-frustoconical portion 2. Thus, the cotters 6 are prevented from falling from the lower end of the inverted-frustoconical portion 2 enlarged by the cotters 6. It also avoids larger thickness of the inverted-frustoconical portion 2 for increasing rigidity as shown in the prior art to lead lightening of the valve spring retainer 1.

The guide projection 5 increases rigidity of the spring-retaining flange 3, thereby preventing upward deformation by reaction force of the valve spring 8.

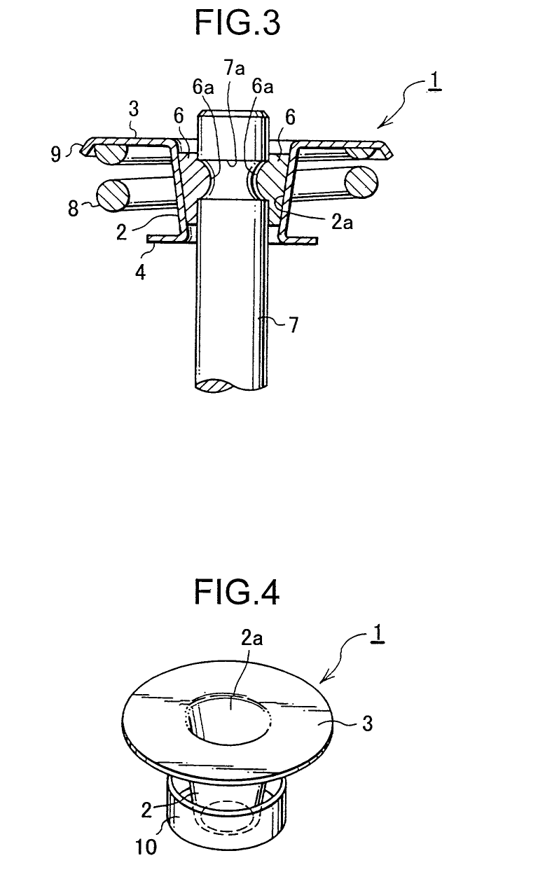

FIG. 3 illustrates the second embodiment of the present invention in which a downward-inclined circumferential projection 9 is provided instead of the guide projection in the first embodiment to prevent sideward deviation of the valve spring. The circumferential projection 9 provides reinforcement to increase rigidity of the spring-retaining flange 3, thereby preventing the flange 3 from upward deformation by reaction force of the valve spring.

Such a circumferential projection 9 may be provided on the spring-retaining flange 3 in the first embodiment as shown by a dotted line in FIG. 2 to increase rigidity.

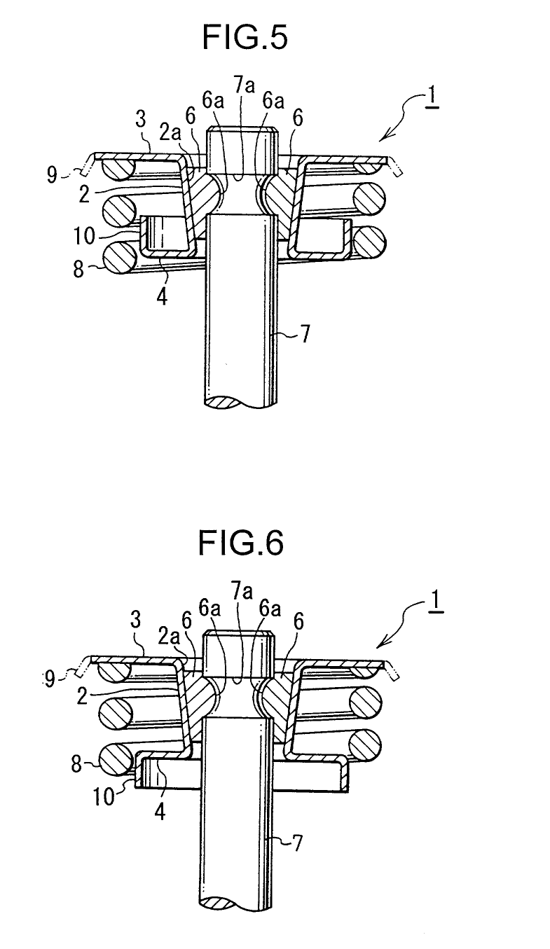

FIG. 4 is a perspective view of the third embodiment of valve spring retainer according to the present invention, and FIG. 5 is a central vertical sectional front view of a valve-operating mechanism which includes the valve spring retainer.

A valve spring retainer 1 in the third embodiment has a flat spring-retaining flange 3 at the upper end of a hollow inverted-frustoconical portion 2. A reinforcement flange 4 similar to the above embodiments and having a diameter slightly larger than those therein has an annular upward guide projection 10 to restrict sideward movement of a valve spring 8. In the third embodiment, the reinforcement flange 4 and the annular guide portion 10 are provided at the lower end of the inverted-frustoconical portion to provide high rigidity at the lower end of the inverted-frustoconical portion 2 and to prevent cotters 6 from falling.

FIG. 6 illustrates the fourth embodiment of the present invention, in which an annular guide projection 10 of a reinforcement flange 4 is projected downward contrary to the third embodiment. In this embodiment, the guide projection 10 achieves reinforcement to increase rigidity at the lower end of a inverted-frustoconical portion 2.

In the third and fourth embodiments, a circumferential projection 9 may be provided at the outer circumference of a spring-retaining flange 3 as shown by dotted lines in FIGS. 5 and 6, thereby restricting sideward movement of the upper end of a valve spring 8 and increasing rigidity of the spring-retaining flange 3.

In the first embodiment, the guide projection 5 of the spring-retaining flange 3 is annular, but may be separate such that two or more arcuate guide projections are integrally formed at a certain distance circumferentially.

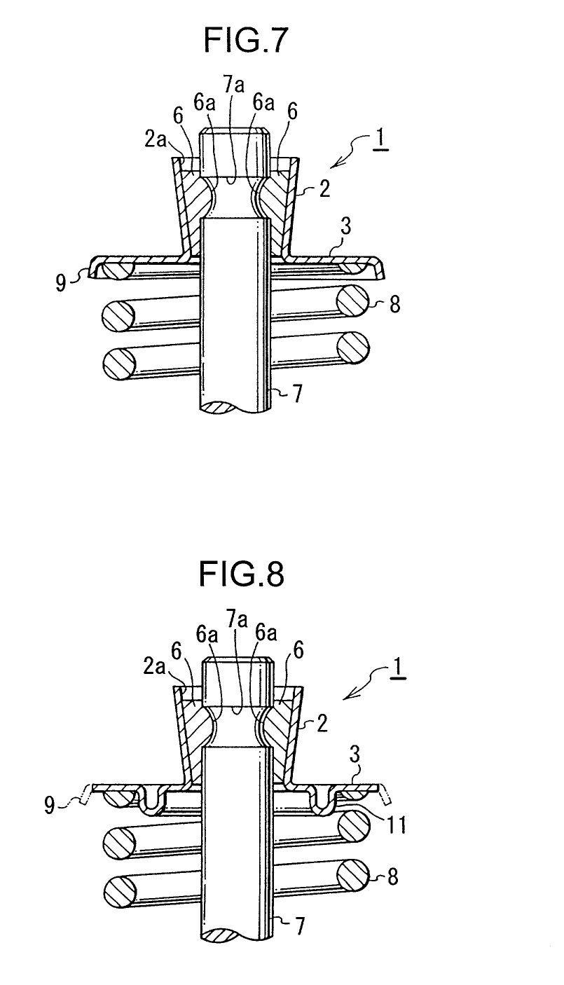

FIG. 7 illustrates the fifth embodiment of a valve spring retainer according to the present invention, in which a valve spring retainer 1 comprises a hollow inverted-frustoconical portion 2 and a spring-retaining flange 3 at the lower end thereof. The retainer 1 is integrally molded from a thin steel plate having thickness of 0.5 to 2 mm by plate working such as stamping, deep drawing and manual spinning.

On the outer circumference of the spring-retaining flange 3, a downward-inclined circumferentail projection 9 for reinforcement similar to the above is provided, thereby restricting sideward movement of the valve spring 8.

When the cotters 6 are fitted, the lower ends of the cotters 6 are coplanar with or slightly lower than the upper surface of the spring-retaining flange 3. Thus, when large force is applied to the cotters 6, downward pressing force applied to the cotters 6 is partially received by the spring-retaining flange 3, thereby preventing the inverted-frustoconical portion 2 from being expanded.

FIG. 8 illustrates the sixth embodiment of the present invention, in which a spring-retaining flange 3 has a downward annular guide projection 11, around which the upper end of a valve spring 8 is engaged on the lower surface of the spring-retaining flange 3 to restrict sideward movement. In this embodiment, the guide projection 11 provides reinforcement to increase rigidity of the spring-retaining flange 3 to prevent upward deformation of the flange 8. A circumferential projection 9 may be formed similar to that in FIG. 7 at the outer circumference of the spring-retaining flange 3 as shown by a dotted line in FIG. 8 to increase rigidity of the spring-retaining flange 3 in addition. In the sixth embodiment, two or more separate arcuate guide projections may be integrally formed at a predetermined distance.

In the fifth and sixth embodiments, the larger-diameter spring-retaining flange 3 is provided at the lower end of the inverted-frustoconical portion 2, The lower end of the inverted-frustoconical portion 2 becomes significantly higher in rigidity than that in the prior art which has a flat spring-retaining flange at the upper end. Even if it comprises a relatively thin plate, there will be no likelihood that the lower end of the inverted-frustoconical portion 2 is expanded by the cotters. Therefore, it avoids increase in thickness of the inverted-frustoconical portion 2, thereby lightening the valve spring retainer 1.

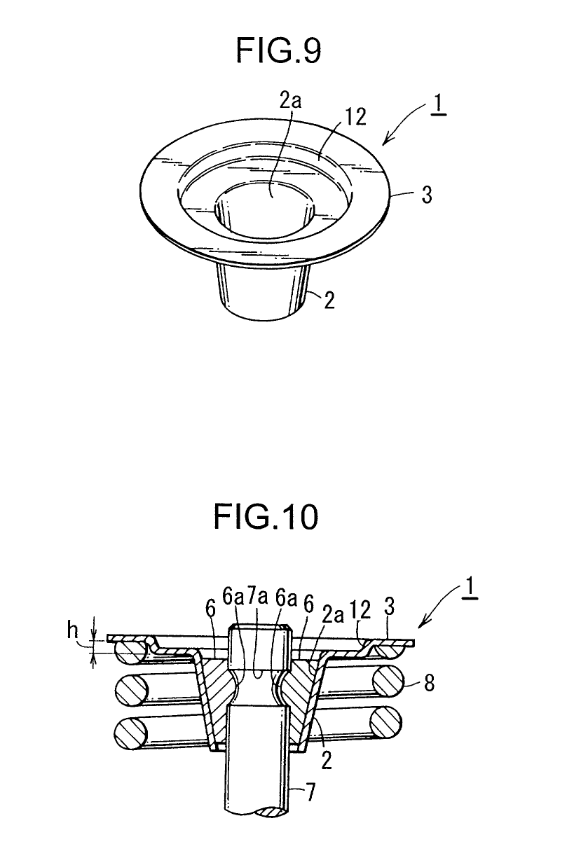

FIG. 9 is a perspective view of the seventh embodiment of a valve spring retainer of the present invention, and FIG. 10 is a central sectional front view of a valve-operating mechanism which includes the retainer. The valve spring retainer 1 comprises an inverted-frustoconical portion 2 which gradually expands in diameter upwards, and a spring-retaining outward flange 3 at the upper end, and is integrally formed from thin steel plates having thickness of 0.5 to 2.0 mm, preferably 1.0 to 1.3 mm by plating such as pressing.

An annular guide portion 12 is formed on the spring-retaining flange 3, and the upper end of a valve spring 8 is pressed on the lower surface of an outer portion slightly higher than an inner portion. The guide portion 12 prevents the upper end of the valve spring 8 from radial movement. A height “h” of the guide portion 12 between the lower surfaces of the inner and outer portions may be set to 1.0 to 3.0 mm, preferably 1.5 to 2.0 mm. The reason therefor will be described as below.

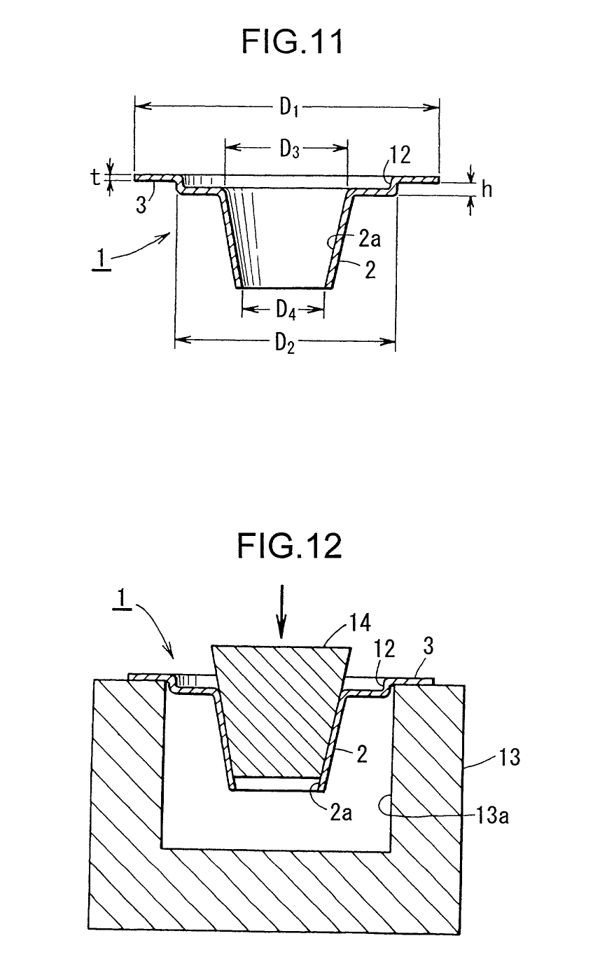

Examples of the seventh embodiment will be described in detail. In FIG. 11, a diameter D, of the spring-retaining flange 3, an external diameter D₂ of the guide portion 12, an internal diameter D₃ of the upper end of the taper bore 2a and an internal diameter D₄ of the lower end of the taper bore 2a are fixed, while the thickness “t” of the retainer and height “h” of the guide portion are varied. Section moduli of the spring-retaining flange 3 are calculated and fatigue strength and deformation are determined. The following Table shows the results thereof.

TABLE

| | | Height “h” | | Deforma- | Fatigue |
|---|---|---|---|---|---|
| | Thickness | of guide | Section | tion | strength by |
| | “t” (mm) | portion (mm) | modulus | (mm) | 10⁷ times |
| Exam- | 1.0 | 1.0 | 2.9 | 0.26 | Broken |
| ple 1 | | | | | |
| Exam- | 1.0 | 1.5 | 4.3 | 0.23 | Broken |
| ple 2 | | | | | |
| Exam- | 1.0 | 1.7 | 5.0 | 0.22 | Not broken |
| ple 3 | | | | | |
| Exam- | 1.0 | 1.8 | 5.3 | 0.20 | Not broken |
| ple 4 | | | | | |
| Exam- | 1.0 | 2.0 | 6.1 | 0.18 | Not broken |
| ple 5 | | | | | |
| Exam- | 12 | 1.5 | 5.1 | 0.20 | Not broken |
| ple 6 | | | | | |
| Exam- | 1.3 | 1.5 | 5.5 | 0.18 | Not broken |
| ple 7 | | | | | |
| Com- | 1.0 | None | 1.3 | 0.29 | Broken |
| parison | | | | | |
| 1 | | | | | |
| Com- | 1.2 | None | 1.9 | 0.28 | Broken |
| parison | | | | | |
| 2 | | | | | |

Deformation was determined by a method as shown in FIG. 12.

By the upper surface of a support jig 13 having a bore 13a, the lower surface around the guide portion 12 of the spring-retaining flange 3 of the valve spring retainer 1 is supported. Then, the upper surface of a tapered pressing member 14 fitted in the bore 2a is pressed in a fatigue test, and deformation of the pressing member 14 is determined and considered as that of the retainer 1.

Fatigue strength is determined by identification of breakage of the valve spring retainer 1 when the valve spring retainer 1 is reciprocated by 10⁷ times by load.

As shown in Examples 1 to 5 in Table, when the thickness “t” of the valve spring retainer is fixed, section modulus of the spring-retaining flange 3 becomes larger to decrease deformation as the height “h” of the guide portion 12 increases.

When the height “h” of the guide portion reaches 1.7 mm, section modulus becomes 5 to provide sufficient fatigue strength. When the height of the guide portion is 1.5 mm or less, section modulus is too small and deformation is too large to achieve sufficient fatigue strength.

When the thickness “t” becomes larger with fixed height “h” of the guide portion as shown in Examples 6 and 7, section modulus of over 5 is obtained with lower deformation to provide sufficient fatigue strength. But larger thickness of the retainer 1 increases weight of the retainer 1.

In the comparative examples 1 and 2 in which the spring-retaining flange is flat without guide portion, the thickness “t” is 1.2 mm to decrease section modulus and to increase deformation. In both examples, rigidity or fatigue strength required in the valve spring retainer is not achieved.

Considering the results in Table, strength of the valve spring retainer 1 is variable depending on section moduli of the spring-retaining flange portion. If the thickness “t” and height “h” of the guide portion 12 are set such that the section modulus is more than predetermined value, sufficient fatigue strength is obtained. Required section modulus is variable depending on specification of an engine, and may be determined thereon.

To achieve both lightening and required strength, not strength “t” of the valve spring retainer 1 but the height “h” of the guide portion 12 may be preferably increased.

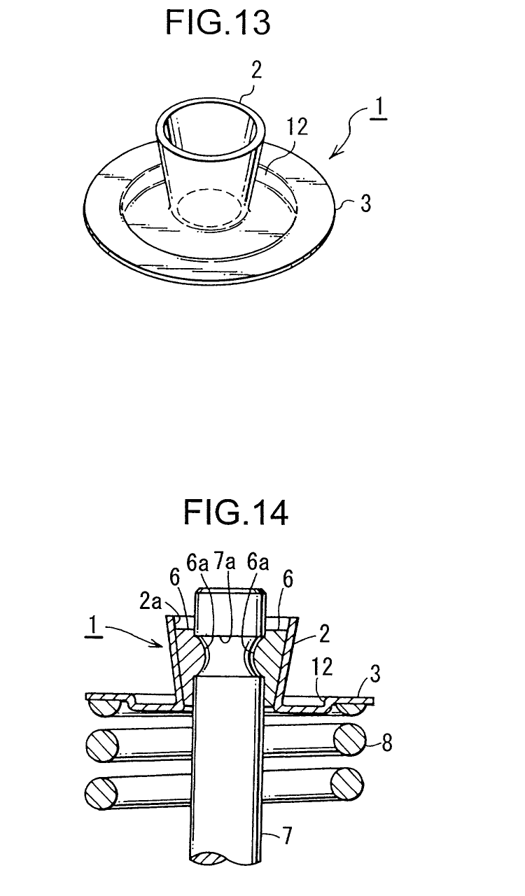

FIG. 13 illustrates a perspective view of the eighth embodiment of a valve spring retainer according to the present invention. FIG. 14 is a central vertical sectional front view of a valve-operating mechanism which includes the retainer 1 in which a spring-retaining flange 3 is provided at the lower end of an inverted-frustoconical portion 2 similar to that in FIG. 7. An annular guide portion 12 is formed on the flange 3. In the eighth embodiment, similar to the above, when the thickness of the retainer 1 is set to 1.0 mm, and height of the guide portion ranges from 1.5 to 2.0 mm, thereby lightening of the retainer 1 without decrease in strength.

The foregoing merely relate to embodiments of the invention. Various changes and modifications may be made by persons skilled in the art without departing from the scope of claims wherein:

What is claimed is:

1. A valve spring retainer in an internal combustion engine, the retainer comprising:
a hollow inverted-frustoconical portion;
an outward spring-retaining flange at an upper end of the frustoconical portion, a lower surface of the spring-retaining flange retaining an upper end of a valve spring; and
an outward reinforcement flange at a lower end of the frustoconical portion to increase rigidity of the retainer.

2. A valve spring retainer as claimed in claim 1 wherein an annular guide projection is provided downward on the lower surface of the spring-retaining flange around the frustoconical portion to restrict sideward movement of the valve spring.

3. A valve spring retainer as claimed in claim 1 wherein a downward-inclined circumferential projection is provided at an outer circumference of the spring-retaining flange to restrict sideward movement of the valve spring.

4. A valve spring retainer as claimed in claim 1 wherein an upward annular guide projection is provided at an outer circumference of the reinforcement flange to restrict sideward movement of the valve spring.

5. A valve spring retainer as claimed in claim 4 wherein a downward-inclined circumferential projection is provided at an outer circumference of the spring-retaining flange.

6. A valve spring retainer as claimed in claim 1 wherein a downward annular guide projection is provided at an outer circumference of the reinforcement flange to restrict sideward movement of the valve spring.

7. A valve spring retainer as claimed in claim 6 wherein a downward-inclined circumferential projection is provided at an outer circumference of the spring-retaining.

8. A valve spring retainer in an internal combustion engine, the retainer comprising:
a hollow inverted-frustoconical portion; and
an outward spring-retaining flange at a lower end of the frustoconical portion, a lower surface of the spring-retaining flange retaining an upper end of a valve spring.

9. A valve spring retainer as claimed in claim 8 wherein a downward-inclined circumferential projection is provided at an outer circumference of the spring-retaining flange to restrict sideward movement of the valve spring.

10. A valve spring retainer as claimed in claim 8 wherein an annular guide projection is provided around the frustoconical portion on the lower surface of the spring-retaining flange to restrict sideward movement of the valve spring and to increase rigidity.

11. A valve spring retainer as claimed in claim 10 wherein a downward-inclined circumferential projection is provided at an outer circumference of the spring-retaining flange.

12. A valve spring retainer as claimed in claim 8 wherein the spring-retaining flange comprises an inner portion which is connected to the frustoconical porion, an outer portion which is slightly higher than the inner portion and an annular guide portion between the inner and outer portions.

13. A valve spring retainer in an internal combustion engine, the retainer comprising:
a hollow inverted-frustoconical portion; and
a spring-retaining flange at an upper end of the frustoconical portion, a lower surface of the flange retaining an upper end of a valve spring, the flange comprising an inner portion, an outer portion which is slightly higher than the inner portion, and a guide portion between the inner and outer portions.

14. A valve spring retainer as claimed in claim 13 wherein a height of the guide portion is 1.0 to 3.0 mm.

15. A valve spring retainer as claimed in claim 14 wherein the height of the guide portion is 1.5 to 2.0 mm.
